(19) United States
(12) Patent Application Publication
(10) Pub. No.: US 2015/0009591 A1
(43) Pub. Date: Jan. 8, 2015

(54) STREAMLINED VOICE COIL ACTUATOR FOR HARD DISK DRIVE

(71) Applicant: HGST Netherlands B.V., Amsterdam (NL)

(72) Inventors: Akiko Kagatsume, Tsukuba (JP); Taisuke Sugii, Toyama (JP); Yoshiyuki Hirono, Chigasaki-shi (JP); Hajime Eguchi, Fujisawa-shi (JP); Takashi Kouno, Kasumigaura-shi (JP)

(21) Appl. No.: 13/937,071

(22) Filed: Jul. 8, 2013

(51) Int. Cl. G11B 5/48

(52) U.S. Cl. CPC G11B 5/4873
USPC 360/254

(57) ABSTRACT

Approaches to improving head positioning accuracy in a hard disk drive, by reducing air pressure fluctuations that would otherwise cause unwanted coil torsion in a voice coil actuator, include a voice coil actuator having a streamlined structure configured to affect the flow of air acting upon a coil-supporting arm. The streamlined structure comprises an upper surface and a lower surface, where the upper surface is sloped downward toward the lower surface and the lower surface is sloped upward toward the upper surface.

### FIELD OF THE INVENTION

Embodiments of the invention relate generally to hard disk drives and more particularly to improving head positioning accuracy by reducing the air pressure fluctuations against the voice coil actuator.

### BACKGROUND

A hard-disk drive (HDD) is a non-volatile storage device that is housed in a protective enclosure and stores digitally encoded data on one or more circular disks having magnetic surfaces (a disk may also be referred to as a platter). When an HDD is in operation, each magnetic-recording disk is rapidly rotated by a spindle system. Data is read from and written to a magnetic-recording disk using a read/write head which is positioned over a specific location of a disk by an actuator.

A read/write head uses a magnetic field to read data from and write data to the surface of a magnetic-recording disk. As a magnetic dipole field decreases rapidly with distance from a magnetic pole, the distance between a read/write head, which is housed in a slider, and the surface of a magnetic-recording disk must be tightly controlled. Further, as recording tracks in HDDs become narrower and narrower, there is a need for more accurate and sustainable head positioning. One of the main factors impairing accurate positioning is airflow caused by rotation of the disk which, when striking the voice coil motor (“VCM”, and also referred to as a voice coil actuator) assembly and associated components, causes head positioning to suffer. Thus, the manner in which airflow disturbances are suppressed in order to restrict unwanted airflow induced effects is an important factor in improving positioning accuracy.

There is a known approach, referred to as a bypass channel, in which airflow that would otherwise strike the actuator arm is diverted. Such a system is implemented using an airflow channel such that airflow flows outside the area of the disk, bypassing the arm. The airflow enters the channel upstream of the arm and returns to inside the disk area downstream of the arm. However, such a diversion of the airflow from the actuator arm may cause undesirable effects on other HDD components to which the diverted airflow is directed.

### SUMMARY OF EMBODIMENTS OF THE INVENTION

Embodiments of the invention are directed to improving head positioning accuracy in a hard disk drive by suppressing airflow disturbances that would otherwise cause unwanted head positioning inaccuracy.

According to an embodiment, a voice coil actuator that actuates an arm/suspension and moves the associated head slider for accessing portions of a magnetic-recording disk, comprises a wire coil, a coil-supporting arm, and a streamlined structure configured to affect the flow of air acting upon the coil-supporting arm. The streamlined structure may be attached to, or may be an integral part of, the coil-supporting arm.

According to an embodiment, the streamlined structure comprises an upper surface and a lower surface, where the upper surface is sloped downward toward the lower surface and the lower surface is sloped upward toward the upper surface. The streamlined structure is configured to affect the flow of air acting upon the coil-supporting arm by affecting the air pressure fluctuations near the coil-supporting arm, for example, to reduce the coil torsion that would otherwise be caused to the coil by such pressure fluctuations.

Embodiments discussed in the Summary of Embodiments of the Invention section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a plan view of an HDD, according to an embodiment of the invention;

FIG. 2 is a plan view of a voice coil actuator, according to an embodiment of the invention; and

FIG. 3 is an end side view of the coil portion of a voice coil actuator, according to an embodiment of the invention.

### DETAILED DESCRIPTION

Approaches to the configuration of a voice coil actuator comprising a streamlined structure of the coil portion, for reducing coil torsion caused by air pressure, are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description of Illustrative Embodiments of the Invention

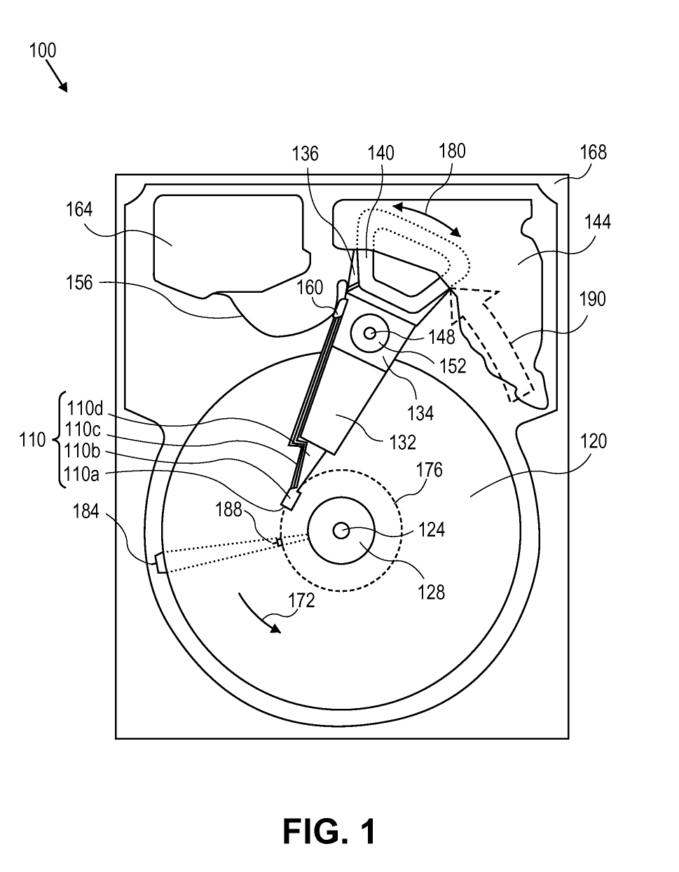

Embodiments of the invention may be used in the context of a hard-disk drive (HDD). In accordance with an embodiment of the invention, a plan view of a HDD 100 is shown in FIG. 1. FIG. 1 illustrates the functional arrangement of components of the HDD including a slider 110b that includes a magnetic-reading/recording head 110a. Collectively, slider 110b and head 110a may be referred to as a head slider. The HDD 100 includes at least one head gimbal assembly (HGA) 110 including the head slider, a lead suspension 110c attached to the head slider, and a load beam 110d attached to the lead suspension 110c. The HDD 100 also includes at least one magnetic-recording disk 120 rotatably mounted on a spindle 124 and a drive motor (not shown) attached to the spindle 124 for rotating the disk 120. The head 110a includes a write element and a read element for respectively writing and reading information stored on the disk 120 of the HDD 100. The disk 120 or a plurality (not shown) of disks may be affixed to the spindle 124 with a disk clamp 128.

The HDD 100 further includes an arm 132 attached to the HGA 110, a carriage 134, a voice-coil motor (VCM), or actuator, that includes an armature 136 including a voice coil 140 attached to the carriage 134; and a stator 144 including a voice-coil magnet. The armature 136 of the VCM is attached to the carriage 134 and is configured to move the arm 132 and the HGA 110 to access portions of the disk 120 being mounted on a pivot-shaft 148 with an interposed pivot-bearing assembly 152. In the case of an HDD having multiple disks, or platters as disks are sometimes referred to in the art, the carriage 134 is called an “E-block,” or comb, because the carriage is arranged to carry a ganged array of arms that gives it the appearance of a comb.

Electrical signals, for example, current to the voice coil 140 of the VCM and write signal to and read signal from the head 110a, are provided by a flexible interconnect cable 156 (“flex cable”). Interconnection between the flex cable 156 and the head 110a may be provided by an arm-electronics (AE) module 160, which may have an on-board pre-amplifier for the read signal, as well as other read-channel and write-channel electronic components. The AE 160 may be attached to the carriage 134 as shown. The flex cable 156 is coupled to an electrical-connector block 164, which provides electrical communication through electrical feedthroughs (not shown) provided by an HDD housing 168. The HDD housing 168 in conjunction with an HDD cover provides a sealed, protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the disk 120 that is affixed to the spindle 124 by the disk clamp 128; as a result, the disk 120 spins in a direction 172. The spinning disk 120 creates a cushion of air that acts as an air-bearing on which the air-bearing surface (ABS) of the slider 110b rides so that the slider 110b flies above the surface of the disk 120 without making contact with a thin magnetic-recording medium of the disk 120 in which information is recorded.

The electrical signal provided to the voice coil 140 of the VCM enables the head 110a of the HGA 110 to access a track 176 on which information is recorded. Thus, the armature 136 of the VCM swings through an arc 180 which enables the HGA 110 attached to the armature 136 by the arm 132 to access various tracks on the disk 120. Information is stored on the disk 120 in a plurality of stacked tracks arranged in sectors on the disk 120, for example, sector 184. Correspondingly, each track is composed of a plurality of sectored track portions, for example, sectored track portion 188. Each sectored track portion 188 is composed of recorded data and a header containing a servo-burst-signal pattern, for example, an ABCD-servo-burst-signal pattern, information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

### Introduction

With further reference to FIG. 1, the spinning of disk 120 in the direction 172 causes air to flow within HDD 100 generally in the direction 172. This airflow 190 (depicted as block arrow 190), in an HDD configured with or without a bypass channel, oftentimes impinges upon the voice coil 140. Consequently, airflow 190 may create undesirable effects such as coil torsion due to the air pressure and its corresponding fluctuations. Coil torsion in turn may cause fluid induced vibration (FIV) that negatively impacts head positioning accuracy.

Embodiments of the invention are directed to improving head positioning accuracy in a hard disk drive by weakening the influence of air pressure fluctuations on the voice coil, which would otherwise cause unwanted coil torsion.

### Voice Coil Having Streamlined Structure

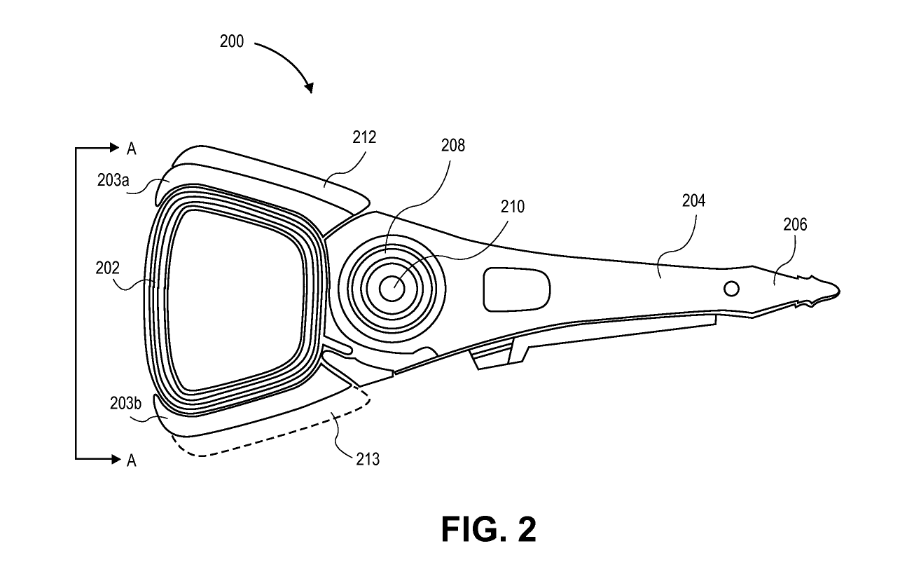

FIG. 2 is a plan view of a voice coil actuator, according to an embodiment of the invention. Voice coil actuator 200 comprises coil-supporting arm 203a and coil-supporting arm 203b (also sometimes referred to as “yokes”), which support a wire coil 202. Operation of the voice coil actuator rotates an arm 204 and a head-gimbal assembly (HGA) 206 about a pivot-shaft 210 via a pivot-bearing 208. The configuration and operation of voice coil actuator 200 is the same as or similar to like components described in reference to FIG. 1, with an additional component as follows.

Voice coil actuator 200 further comprises a streamlined structure 212 coupled to, or part of, at least one of coil-supporting arm 203a and coil-supporting arm 203b. Streamlined structure 212 is shown coupled only with coil-supporting arm 203a but a similar streamlined structure 213 may optionally be similarly configured on the other side of the wire coil 202, coupled with coil-supporting arm 203b. The configuration of streamlined structure 212 may vary from implementation to implementation, depending on, for example, the configuration of wire coil 202 and coil-supporting arms 203a, 203b. For example, streamlined structure 212 may span the entire length of coil-supporting arm 203a or span just a portion of coil-supporting arm 203a. Furthermore, for example, streamlined structure 212 may also directly cover or overlay part of wire coil 202.

Streamlined structure 212 may be an integral part with coil-supporting arm 203a, or alternatively may be a separate part attached to coil-supporting arm 203a and/or overlaying coil-supporting arm 203a (e.g., like a fairing). Regardless, a function of streamlined structure 212 is to weaken the effect of air pressure fluctuations on coil 202 from the disk-induced airflow 190 (FIG. 1).

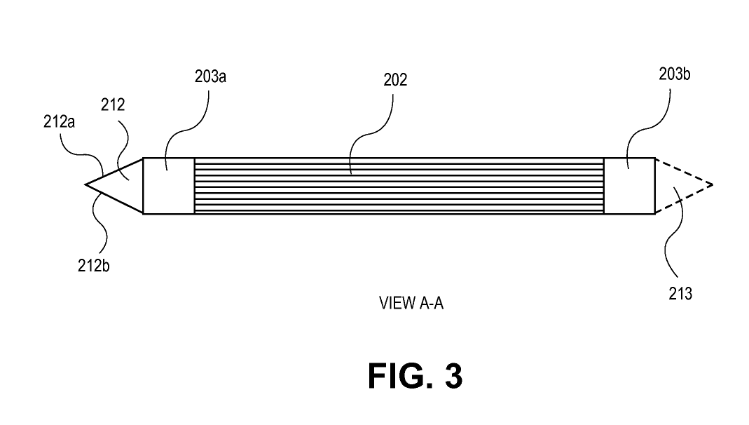

FIG. 3 is an end side view of the coil portion of the voice coil actuator 200, along line A-A of FIG. 2, according to an embodiment of the invention. As can be seen in the depiction of FIG. 3, streamlined structure 212 comprises sloped or angled surfaces 212a and 212b, which embody the streamlined feature of streamlined structure 212. The upper surface 212a is sloped downward toward the lower surface 212b, and lower surface 212b is sloped upward toward the upper surface 212a. Thus, streamlined structure 212 serves to affect the flow of air impacting, and the resultant forces acting upon, coil-supporting arm 203a and coil 202.

In particular, and in comparison with a voice coil actuator that does not include such a streamlined structure coupled with coil-supporting arm 203a, streamlined structure 212 serves to reduce the air pressure and air pressure fluctuations impinging upon coil-supporting arm 203a and coil 202. Stated otherwise, streamlined structure 212 provides for a more aerodynamic surface than does coil-supporting arm 203a alone. The exact shape of the streamlined structure 212 may vary from implementation to implementation, as long as it comprises a streamlined or aerodynamic shape. For example, streamlined structure 212 may. comprise ore, and more complex, surfaces than as illustrated as upper surface 212a and lower surface 212b of FIG. 3. For example, the upper surface 212a and the lower surface 212b of streamlined structure 212 may, but need not necessarily, meet at a point-edge as depicted in FIG. 3.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A voice coil actuator for moving an arm and a head slider to access portions of a magnetic-recording disk, the voice coil actuator comprising:
a wire coil configured to carry electrical current;
a coil-supporting arm supporting said coil; and
a streamlined structure configured to affect the flow of air acting upon said coil-supporting arm by affecting air pressure fluctuation near said coil-supporting arm, said streamlined structure comprising an upper surface sloped downward from said coil-supporting arm and a lower surface sloped upward from said coil-supporting arm.

2. The voice coil actuator of claim 1, wherein said streamlined structure is attached to said coil-supporting arm.

3. The voice coil actuator of claim 1, wherein said streamlined structure is an integral part with said coil-supporting arm.

4. (canceled)

5. The voice coil actuator of claim 1, wherein said streamlined structure overlays said coil-supporting arm.

6. (canceled)

7. The voice coil actuator of claim 1, wherein said coil-supporting arm is a first coil-supporting arm and said streamlined structure is a first streamlined structure configured to affect the flow of air acting upon said first coil-supporting arm, said voice coil actuator further comprising:
a second coil-supporting arm supporting said coil and opposing said first coil-supporting arm; and
a second streamlined structure configured to affect the flow of air acting upon said second coil-supporting arm.

8. (canceled)

9. The voice coil actuator of claim 1, wherein said streamlined structure is configured to affect the flow of air acting upon said coil-supporting arm to affect torsion of said coil.

10. A hard disk drive (HDD), comprising:
a head slider comprising a magnetic write head;
an arm, to which said head slider is coupled;
a magnetic-recording disk rotatably mounted on a spindle;
a voice coil motor (VCM) configured to move the arm and head slider to access portions of the magnetic-recording disk, said voice coil motor comprising:
a wire coil configured to carry electrical current;
a coil-supporting arm supporting said coil; and
a streamlined structure configured to affect the flow of air acting upon said coil-supporting arm by affecting air pressure fluctuation near said coil-supporting arm, said streamlined structure comprising an upper surface sloped downward from said coil-supporting arm and a lower surface sloped upward from said coil-supporting arm.

11. The HDD of claim 10, wherein said streamlined structure is attached to said coil-supporting arm.

12. The HDD of claim 10, wherein said streamlined structure is an integral part with said coil-supporting arm.

13. (canceled)

14. The HDD of claim 10, wherein said streamlined structure overlays said coil-supporting arm.

15. (canceled)

16. The HDD of claim 10, wherein said coil-supporting arm is a first coil-supporting arm and said streamlined structure is a first streamlined structure configured to affect the flow of air acting upon said first coil-supporting arm, said voice coil actuator further comprising:
a second coil-supporting arm supporting said coil and opposing said first coil-supporting arm; and
a second streamlined structure configured to affect the flow of air acting upon said second coil-supporting arm.

17. (canceled)

18. The HDD of claim 10, wherein said streamlined structure is configured to affect the flow of air acting upon said coil-supporting arm to affect torsion of said coil.

19. A method for accurately positioning a head slider, coupled to a voice coil actuator, to access portions of a recording disk by a read/write head, the method comprising:
applying an electrical signal to a voice coil constituent to said voice coil actuator and supported by a coil-supporting arm comprising a streamlined structure shaped to moderate air pressure fluctuations impinging upon said coil-supporting arm to inhibit fluid induced vibration that would otherwise negatively impact the positioning accuracy of said head.
